(19) United States
(12) Patent Application Publication
(10) Pub. No.: US 2013/0295537 A1
(43) Pub. Date: Nov. 7, 2013

(54) MATHEMATICS EDUCATION SERVICE SYSTEM, SERVICE METHOD THEREOF, APPARATUS FOR ANALYZING AND GENERATING MATHEMATICAL PROBLEMS, AND METHOD THEREOF

(71) Applicants: ISCILAB CORPORATION, Seoul (KR); SK TELECOM CO., LTD., Seoul (KR)

(72) Inventors: Keun Tae PARK, Seongnam Si (KR); Nam Sook Wee, Seoul (KR); Doo Seok Lee, Seoul (KR); Jung Kyo Sohn, Seoul (KR); Haeng Moon Kim, Gwacheon (KR); Yong Gil Park, Seongnam Si (KR); Dong Hahk Lee, Seoul (KR)

(21) Appl. No.: 13/939,788

(22) Filed: Jul. 11, 2013

Related U.S. Application Data
(63) Continuation of application No. PCT/KR2012/000269, filed on Jan. 11, 2012.

(30) Foreign Application Priority Data
Jan. 11, 2011 (KR) 10-2011-0002591

(51) Int. Cl. G09B 5/00

(52) U.S. Cl. CPC G09B 5/00
USPC 434/201

(57) ABSTRACT

The present disclosure provides a mathematics education service system includes a problem storing unit to store at least one mathematical problem; a transform method executing unit to execute a plurality of problem transform methods; a problem separating unit to collect equations used in the mathematical problem, separate one or more terms from the collected equations by parsing the collected equations, and separate a constant and a variable from each of the separated one or more terms; and a problem generating unit to generate another applied problem of the mathematical problem by applying at least one of the problem transform methods (i) to the collected equations, and (ii) to the constant and the variable of each of the separated one or more terms, wherein the system is configured to provide the mathematical problem and the generated another problem are provided to a learner terminal.

### CROSS-REFERENCE TO RELATED APPLICATION

The present application is a continuation of International Patent Application No. PCT/KR2012/000269, filed Jan. 11, 2012, which is based on and claims priority to Korean Patent Application No. 10-2011-0002591, filed on Jan. 11, 2011. The disclosures of the above-listed applications are hereby incorporated by reference herein in their entirety.

### FIELD

The present disclosure relates to a mathematics education service system and method, and a mathematical problem analyzing and generating apparatus and method, which can provide transformed mathematical problems.

### BACKGROUND

The statements in this section merely provide background information related to the present disclosure and may not constitute prior art.

Recently, as surrounding environments have been variously changed with the utilization of Internet and computer, education environment is also rapidly changing. In particular, development of various education media enables learners to select and use broader learning methods. Among them, an Internet-based education service has become one of popular teaching-learning methods because it can overcome the constraints of time and space and provide educations at low cost.

In order to meet such trends, technology related to e-learning has been developed rapidly, and now, people can see provisions of customized education services that have been impossible in offline educations due to limited human/material resources. For example, learning offered by level subdivided according to a learner's individuality and capability makes each learner's individualized education contents available out of known uniform education methods.

The inventor(s) has, however, noted that even in such customized education services, most education contents having been currently provided take one-way cramming method of teaching. That is, if a teacher gives a lecture based on a level of a learner, the lecture participant can check the personal learning performance through an evaluation process after passing through a separate offline learning process.

The education service provided to date through the Internet has a little difference from the known offline teaching method in that learning performance depends on the offline effort of the learner, who takes the lecture. Accordingly, for the sake of improvement in the learner's actual capability, the functions of the education services are not fully exhibited in an Internet-based education environment that has the potential of bidirectional education.

The inventor(s) has noted that a self directed learning method has attracted attention as one of active learning methods for respecting a learner's individuality and developing an individual's potential capacities as much as possible. The self directed learning is performed in such a manner that a learner takes the lead by searching human/material resources of learning for meeting inspired learning demands and then evaluates the learning result by using appropriate approach strategy.

On the other hand, in the case of providing a mathematics education service via the Internet, it is common that the same types of mathematical problems are provided to all learners. Regarding a single mathematical problem, such a mathematics education service is intended to ensure the same type of the mathematical problem by randomly changing numbers, which are given in a statement part of the mathematical problem, to other numbers.

However, the inventors have noted that providing problem generations just by changing numbers in the given statement of the mathematical problem with such a mathematics education service method results in superficial problem variations. As a result, such a mathematical problem variation received would appear to a learner as a mere repetition.

In addition, a successful case of solving a given problem might be the achievement of the learner who is well acquainted with the exact evaluation factors as intended by an examiner. Otherwise, this may be the result of simply memorizing a mathematical problem and its solution or the effect of simply applying a formula without thinking. The inventor(s) has experienced that in consideration of such circumstances, there is a need for the development of a mathematics education service system that can provide a transformed mathematical problem, instead of simply changing numbers to other variations in a statement part of a mathematical problem, so as to enhance a learner's understanding and enable the learner to be exactly well acquainted with the exact evaluation factors as intended by an examiner.

### SUMMARY

In accordance with some embodiments, a mathematics education service system for providing a mathematics education service to a learner terminal comprises a problem storing unit, a transform method executing unit, a problem separating unit and a problem generating unit. The problem storing unit is configured to store at least one mathematical problem. The transform method executing unit is configured to execute a plurality of problem transform methods. The problem separating unit is configured to collect equations used in the mathematical problem, separate one or more terms from the collected equations by parsing the collected equations, and separate a constant and a variable from each of the separated one or more terms. And the problem generating unit is configured to generate another applied problem of the mathematical problem by applying at least one of the problem transform methods (i) to the collected equations, and (ii) to the constant and the variable of each of the separated one or more terms. T mathematics education service system is also configured to provide the mathematical problem and the generated another problem are provided to a learner terminal.

In accordance with some embodiments, an apparatus for analyzing and generating mathematical problems comprises a problem separating unit, a transform method executing unit and a problem generating unit. The problem separating unit is configured to collect equations used in a mathematical problem, separate one or more terms from the collected equations by parsing the collected equations, and separate a constant and a variable from each of the separated one or more terms. The transform method executing unit is configured to execute a plurality of problem transform methods. And the problem generating unit is configured to generate another applied problem of the mathematical problem by applying at least one of the problem transform methods (1) to the collected mathematical problems, and (2) to the constant and the variable of each of the separated one or more terms

### BRIEF DESCRIPTION OF DRAWINGS

FIG. 1 is a schematic diagram of a mathematics education service system according to at least one embodiment of the present disclosure;

FIG. 2 is a schematic diagram of a mathematical problem analyzing and generating apparatus according to at least one embodiment of the present disclosure;

FIG. 3 is an exemplary diagram of a tree structure for describing analysis of a mathematical problem according to at least one embodiment of the present disclosure;

FIG. 4 is a schematic diagram of a cloud computing service providing apparatus according to at least one embodiment of the present disclosure;

FIG. 5 is a flowchart of a mathematics education service method according to at least one embodiment of the present disclosure;

FIG. 6 is a flowchart of a mathematical problem analyzing and generating method according to at least one embodiment of the present disclosure; and

FIG. 7 is a flowchart of a cloud computing service providing method according to at least one embodiment of the present disclosure.

### DETAILED DESCRIPTION

The present disclosure has been made in an effort to solve the above-mentioned limitations, and provide a mathematics education service system and method, and a mathematical problem analyzing and generating apparatus and method, which can provide transformed mathematical problems so as to enhance a learner's understanding and enable a learner to be well acquainted with the exact evaluation factors as intended by an examiner.

The following describes a mathematics education service system and method, a mathematical problem analyzing and generating apparatus and method, and a cloud computing service providing apparatus and method for providing a mathematical problem analyzing and generating service in detail with reference to the accompanying drawings.

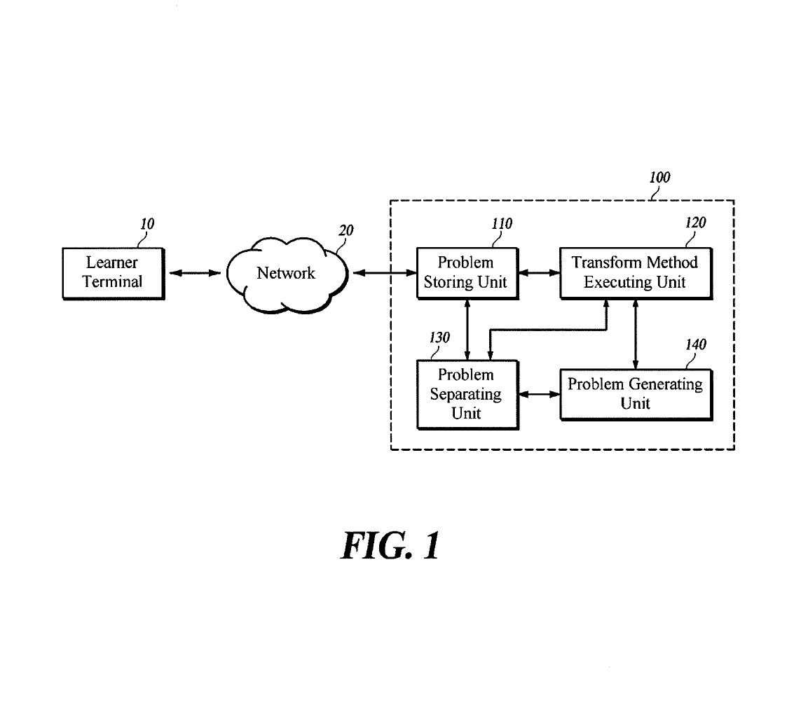

FIG. 1 is a schematic diagram of a mathematics education service system according to at least one embodiment of the present disclosure. Referring to FIG. 1, a learner terminal 10 is connectable to a mathematics education service system 100 via a network 20. The learner terminal 10 may be applied to diverse wired/wireless environments. The learner terminal 10 may include a personal digital assistant (PDA), a cellular phone, a smartphone and the like, which are classified by terminal form factors, and a personal communication service (PCS) phone, a Global System for Mobile (GSM) phone, a wideband code division multiple access (WCDMA) phone, a CDMA-2000 phone, a mobile broadband system (MBS) phone and the like, which are classified based on communication schemes. The MBS phone refers to a terminal to be used in a next-generation system which is under discussion. In addition, the network 20 collectively refers to an Internet network, a communication network such as CDMA, WCDMA, GSM, long term evolution (LTE), evolved packet core (EPC) and the like, a connection network of a next-generation mobile communication system, and a cloud computing connection network between a cloud computing service providing apparatus and a terminal. The cloud computing refers to a computer environment in which information is permanently stored in a server on the Internet and is temporarily stored in a client terminal such as a desktop computer, a tablet computer, a notebook, a netbook, a smartphone and the like. The cloud computing connection network refers to a computer environment connection network in which all pieces of user information are stored in a server on the Internet, and each user is allowed to use the pieces of user information through various IT devices anywhere anytime.

The mathematics education service system 100 may include a problem storing unit 110, a transform method executing unit 120, a problem separating unit 130, and a problem generating unit 140. The problem storing unit 110, transform method executing unit 120, problem separating unit 130 and problem generating unit 140 may constitute elements of a single server, or may be implemented with respective servers to perform mutual operations. Further, other components of the mathematics education service system 100, such as the transform method executing unit 120, the problem separating unit 130, and the problem generating unit 140 are implemented by one or more processors and/or application-specific integrated circuits (ASICs).

The problem storing unit 110 may store various types of basic problems of mathematical problems. For example, the problem storing unit 110 may store various classified types of basic problems of a quadratic equation, a cubic equation, a trigonometric function, a limit, and the like.

The transform method executing unit 120 executes a plurality of problem transform methods, including a problem transform method by number and equation manipulation, a problem transform method by rephrasing, and a problem transform method by proposition manipulation. Herein, the problem transform method by the number and equation manipulation may be classified into a problem transform method by number manipulation and a problem transform method by equation manipulation.

The problem transform method by the number manipulation transforms a relevant basic problem by transforming numbers included in a parameter set of each basic problem stored in the problem storing unit 110. The problem transform method by the number manipulation can be mainly applied to problems for arithmetic drills. In addition, the problem transform method by the equation manipulation substitutes other equations for equations used in a statement part of each basic problem stored in the problem storing unit 110. Specifically, after generating a new equation (hereinafter, “new” is referred to as at least one of “another,” “alternative,” “applied,” “modified,” “created,” and so on) by deleting or adding a term from or to the equation given in the statement part of the basic problem, or after generating a new equation by appropriate arithmetic operation among equations, the new equation is substituted for the equation included in the original basic problem. A solution structure of such a transformed problem is the same as the case of the number manipulation, but an answer may be different.

The transform method executing unit 120 executes the problem transform method by the rephrasing to thereby generate a transformed problem by rephrasing a statement part of a basic problem stored in the problem storing unit 110. Even though there exists a difference in problem statement expression between the basic problem and the transformed problem, the solutions are completely identical to each other. The problem transform by the rephrasing differs from the problem transform by equation substitution. If a problem statement is differently expressed, even though the structures of the basic problem and the transformed problem are completely identical to each other, a learner may psychologically recognize the problems as different, and may feel the transformed problem easier or harder than the basic problem, depending on situations. The rephrasing of the problem statement may be clarifying or easing the problem to understand, or may be a camouflaging or complicating it to understand. Therefore, such a problem transform may be useful for measuring a learner's ability to understand mathematical problems.

The problem transform method by the proposition manipulation may be classified into a problem transform method using dependency of conditions, a problem transform method by inverse of proposition, and a problem transform method by addition or deletion of conditions. The problem transform method using the dependency of conditions transforms the problem by using a mutual relationship of conditions within a problem statement. In addition, the problem transform method by the inverse of proposition generates a new problem (i.e., another problem generated) by exchanging a condition part and a goal part of a problem. Moreover, the problem transform method by the addition or deletion of conditions generates a new problem by adding or deleting conditions to or from a condition part of a problem. The degree of change from a basic problem is greater in the problem transform by the rephrasing than in the problem transform by the number and equation manipulation, and is greater in the problem transform by the proposition manipulation than in the problem transform by the rephrasing.

The execution of the problem transform method by the transform method executing unit 120 is not limited to the above-described problem transform methods, and various problem transform methods can also be used.

The problem separating unit 130 collects equations used in mathematical problems, separates one or more terms by parsing the collected equations, and separates a constant and a variable from each of the separated one or more terms. At this time, the problem separating unit 130 may divide a mathematical problem into a condition part and a goal part. Examples of condition implication words in the mathematical problem include ‘with respect to’, ‘if’, ‘assuming’, ‘let's set’, and ‘however’. Besides them, there may exist various condition implication words which may be collected to set a group of condition implication words before storing. Since sentences used in a general mathematical problem are standardized, it is not difficult to preset and store a group of condition implication words. A mathematical problem may be divided into a condition part and a goal part, based on the set group of condition implication words.

The problem generating unit 140 generates a new mathematical problem through transform of a basic problem stored in the problem storing unit 110 by applying at least one problem transform method: (1) to the equations collected by the problem separating unit 130; and (2) to the constant and the variable of each of the separated one or more terms.

The mathematics education service system 100 provides the learner terminal 10, connected via the network 20, with the basic problem stored in the problem storing unit 110 or the mathematical problem generated by the problem generating unit 140.

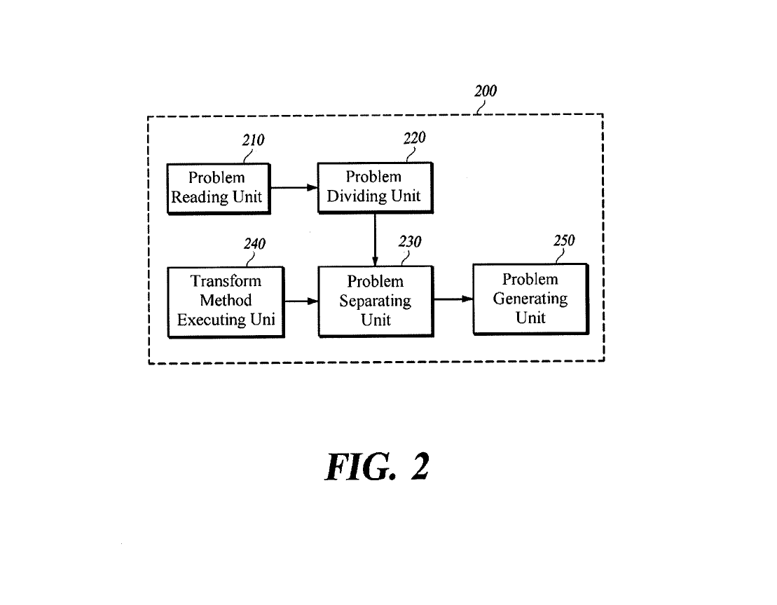

FIG. 2 is a schematic diagram of a mathematical problem analyzing and generating apparatus according to at least one embodiment of the present disclosure. The mathematical problem analyzing and generating apparatus 200 according to at least one embodiment of the present disclosure may include a problem reading unit 210, a problem dividing unit 220, a problem separating unit 230, a transform method executing unit 240, and a problem generating unit 250. The mathematical problem analyzing and generating apparatus 200 may operate as the element of the mathematics education service system 100 described above with reference to FIG. 1, and may be implemented with a portable learner terminal. Other components of the mathematical problem analyzing and generating apparatus 200, such as the problem reading unit 210, the problem dividing unit 220, the problem separating unit 230, the transform method executing unit 240, and the problem generating unit 250 are implemented by one or more processors and/or application-specific integrated circuits (ASICs).

The problem reading unit 210 reads a statement of a mathematical problem. Generally, the statement of the mathematical problem includes a combination of natural language texts and equations. Herein, for convenience, it is assumed that the equation is expressed by a content mathematical markup language (MathML). However, the equation may not be expressed by the content MathML, and the equation may also be described by a certain different language in which each number of the equation and the meaning of the equation are assigned.

The problem dividing unit 220 divides the statement of the mathematical problem into a condition part and a goal part. As described above, examples of condition implication words in the mathematical problem include ‘with respect to’, ‘if’, ‘assuming’, ‘let's set’ and ‘however’. Besides them, there may exist various condition implication words which may be collected to set a group of condition implication words before storing. The mathematical problem may be divided into a condition part and a goal part, based on the set group of condition implication words. For example, if the mathematical problem is a quadratic equation problem just like a problem “when two roots of an equation ‘2x²+3x+1=0’ are α and β, find α+β and αβ″, the condition part is “when two roots of an equation 2x²+3x+1=0 are α and β′, and the goal part is ‘find α+β and αβ′. Herein, the mathematical problem of the quadratic equation is denoted by OP1, which means an original problem 1.

The problem separating unit 230 collects equations used in the mathematical problem, separates one or more terms by parsing the collected equations, and separates a constant and a variable from each of the separated terms. The condition part of the mathematical problem may include a plurality of conditions. For example, in case of the above-described mathematical problem OP1, the condition part includes two items of COND1=‘equation 2x²+3x+1=0’ and COND2=‘two roots are α and β’. For the purpose of division into a plurality of conditions, the condition part may be separated by the front and rear of a connective such as ‘and’, its synonym or the like. Herein, COND1=‘equation 2x²+3x+1=0’ and COND2=‘two roots are α and β’ include one and two equations, respectively. In addition, the goal part includes two equations: ‘α+β’ and ‘αβ’. It is assumed that the groups of equations corresponding to the two conditions are COND1_EQ={‘2x²+3x+1=0’) and COND2={‘α’, ‘β’}, respectively, and the group of equations corresponding to the goal part is GOAL_EQ={‘α+⊕’, ‘αβ’}. When the equations used in the mathematical problem are collected in the above manner, the problem separating unit 230 parses the equations included in each of the conditions. The parsing can separate terms from the equations, and can separate a constant and a variable included in each of the terms. The contents based MathML of the equation ‘2x²+3x+1=0’ is expressed as follows:

<math display = ‘block’>
<apply>
<eq/>
<apply>
<plus/>
<apply>
<plus/>
<apply>
<times/>
<cn>2</cn>
<apply>
<power/>
<ci>x</ci>
<cn>2</cn>
</apply>
</apply>
<apply>
<times/>
<cn>3</cn>
<ci>x</ci>
</apply>
</apply>
<cn>1</cn>
</apply>
<cn>0</cn>
</apply>
</math>

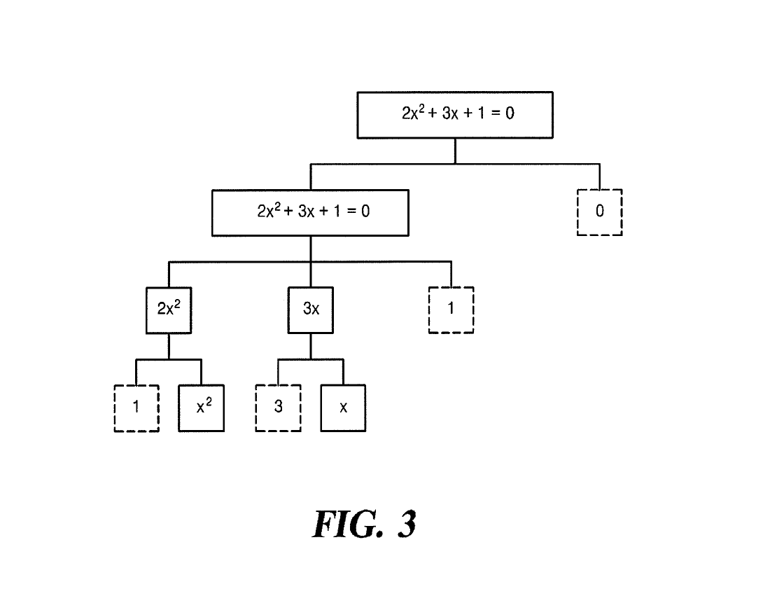

The content MathML expression of the above equation has a tree structure, and this expression includes information about how the terms are added and what are the constant and the variable in each of the terms. The tree structure of the contents based MathML expression of the equation ‘2x²+3x+1=0’ is shown in FIG. 3.

This structure is an equation including three terms on the left-hand side, and informs that each of the terms includes the product of a coefficient (a rectangle indicated by a dotted line) and an unknown or a variable. In addition, the order of adding each of the terms (from left to right) can also be seen. In such an equation structure, a change of a coefficient, a change of a term position, an arithmetic operation of equations and the like can be automatically performed. When assuming that each coefficient included in the rectangle indicated by the dotted line is a parameter value, the collection of these parameters is denoted by ‘PARAM’.

The transform method executing unit 240 executes a plurality of problem transform methods, including a problem transform method by number and equation manipulation, a problem transform method by rephrasing, and a problem transform method by proposition manipulation.

The problem generating unit 250 generates a new applied mathematical problem by applying at least one problem transform method to the collected equations, and the constant and the variable of each of the separated terms.

First, an example of the problem transform by the number manipulation will be described.

Assuming that a problem transformed by the number manipulation of the original problem OP1 is TP1, the transformed problem TP1 of the original problem OP1 may be given as follows: ‘when two roots of an equation 2x²+x+3=0 are α and β, find α+β and αβ’.

The transformed problem TP1 may be generated by changing coefficients of the quadratic equation in the original problem OP1, that is, parameter values included in the PARAM. In this case, the transformed problem TP1 and the original problem OP1 are identical to each other in view of the order of the terms of the quadratic equation, and are also identical to each other in that the answers to obtain are the sum of the two roots and the product of the two roots.

Next, an example of the problem transform by the equation manipulation will be described.

Assuming that the problem transformed by the equation manipulation is TP2, the transformed problem TP2 of the original problem OP1 may be given as follows: “when two roots of an equation 2x²+3x+1=0 are α and β, find α+β+αβ”.

The transformed problem TP2 substitutes a single equation ‘α+β+αβ’ for equations ‘α+β’ and ‘αβ’, which are the equations of the goal part in the original problem OP1. In this case, when generating a new equation to be substituted, a manipulation of adding the two equations may be performed. However, the equation manipulation is not limited to the addition, and equation manipulations using various arithmetic operations, such as multiplication, division or subtraction, may also be performed.

If figures/numbers or equations of the original problem are randomly substituted with new figures/numbers or new equations, no answer to the problem may exist. As a preventive measure, a range of substitutable figures/numbers or equations may be preset, or available figures/numbers or equations may be arranged and stored. Types of the manipulation through the arithmetic operations of numbers and equations may be preset and be selected randomly upon the problem transform. Such a setting range may be set in advance to the problem group or may be set to each problem.

Next, an example of the problem transform by the rephrasing will be described.

Examples of the problem transform method by the rephrasing include a method of changing order of arrangement of terms in collected equations, a method of factorizing or expanding collected equations, a method of expressing collected equations with words, a method of abbreviating a target object expressed with words into an equation, and a method of substituting equations with graphs or pictures. Among the various problem transform methods, an example of a transformed problem generated using the method of changing the order of arrangement of terms in the collected equations will be described.

Assuming that the transformed problem generated using the method of changing the order of arrangement of terms in the collected equations is TP3, the transformed problem TP3 of the original problem OP1 may be given as follows: ‘when two roots of an equation 3x+2x²=−1 are α and β, find α+β and αβ’. In this case, the transformed problem TP3 is completely identical to the original problem OP1. However, in a case where the transformed problem such as TP3 is provided, a learner obtains a wrong answer if the learner simply memorizes that the sum of two roots can be found by dividing the middle number by the foremost number and then inverting the sign of the resulting value. In order to automatically perform the transform such as TP3, terms have only to be changed randomly on the left-hand side and the right-hand side of the tree structure of FIG. 3.

Next, another example of the problem transform by the rephrasing will be described.

Assuming that the transformed problem by the rephrasing is TP4, the transformed problem TP4 of the transformed problem TP2 may be given as follows: ‘when two roots of an equation 2x²+3x+1=0 are α and β, find (α+1)(β+1)−1’. That is, the transformed problem TP4 is given by rephrasing the transformed problem TP2, in particular, the goal part thereof. The goal part equation ‘α+β+αβ’ is an equation completely identical to ‘(α+1)(β+1)−1’, but the learner may feel the transformed problem TP4 more difficult than the transformed problem TP2. As in the case of the problem transform method by the number and equation manipulation, the transform may be automatically performed by presetting various expressions of given equations and randomly selecting them.

Next, an example of the problem transform using the dependency of conditions will be described.

In order to easily describe the problem transform method using the dependency of conditions, it is assumed that the condition part of the mathematical problem includes two conditions (hereinafter, denoted by COND1 and COND2, respectively). If an answer to the problem (hereinafter, denoted by ANS) is given, the problem becomes one true proposition as follows.

COND1 ̂ COND2→ANS

where ‘̂’ denotes a logic operation ‘AND’. If the two following propositions are true, each proposition can be converted into one problem.

COND1 ̂ ANS→COND2,

ANS ̂ COND2→COND1

In this case, COND1, COND2 and ANS are mutually dependent, and any two of them imply the remaining one.

Assuming that the original mathematical problem OP2 is ‘find x³+y³ for x and y satisfying two equations x²+y²=5 and x+y=3 at the same time, the answer of the mathematical problem OP2 is 9. The mathematical problem can be transformed to the proposition as follows and becomes a true proposition.

(x²+y²=5)̂(x+y=3)̂(x and y are real numbers)→(x³+y³=9)

This proposition can be converted as follows:

(x²+y²=5)̂(x³+y³=9)̂(x and y are real numbers)→(x+y=3)

The mathematical problem OP2 can be transformed into the problem ‘find x+Y for x and y satisfying two equations x²+y²=5 and x³+y³=9 at the same time’. Assuming that the transformed problem is TP5, the transformed problem TP5 is more difficult than the original mathematical problem OP2, and additional techniques are required even though the same type of equations are used when solving the mathematical problem.

Next, an example of the problem transform by the inverse transform will be described.

A new problem can be generated by exchanging the roles of the condition part and the goal part in the mathematical problem. The problem transformed in such a manner is an inverse problem of the original mathematical problem. When the condition proposition expression of the original mathematical problem is COND→ANS, its inverse proposition, ANS→COND may also be true. This enables making the inverse problem. Such a type of the problem transform is meaningful to reveal whether the learner exactly knows what the examiner intends to evaluate by making the learner solve the inverse problem. This can generate the transformed problem, which is transformed by the inverse transform of the original mathematical problem OP1, that is, the transformed problem of ‘when two roots of a quadratic equation are α and β, find a quadratic equation of which the sum of the two roots is α+β=− 3/2 and the product of the two roots is αβ=½. Assuming that the transformed problem is TP6, some learners may solve the original mathematical problem OP1, but not the inversely transformed problem TP6.

Next, an example of the problem transform by the addition or deletion of conditions will be described.

The problem transform method by the addition or deletion of conditions generates a new problem by adding or deleting conditions to or from a condition part of a mathematical problem. For example, in a case where the condition part includes k conditions COND1, COND2, . . . , CONDk, a new problem is generated when the conditions are deleted or added.

Generally, if the condition is added to the condition part of the problem, the problem tends to become easier, and if the condition is deleted, the problem tends to become more difficult. For example, assuming that the transformed problem TP7 by the addition or deletion of conditions is ‘when two roots of a quadratic equation is α and β, find a quadratic equation of which the sum of the two roots is α+β=− 3/2, the product of the two roots is αβ=½, and the coefficient of a quadratic term is 2’, the transformed problem TP7 represents a case where a condition that ‘the coefficient of the quadratic term is 2’ is added to the transformed problem TP6.

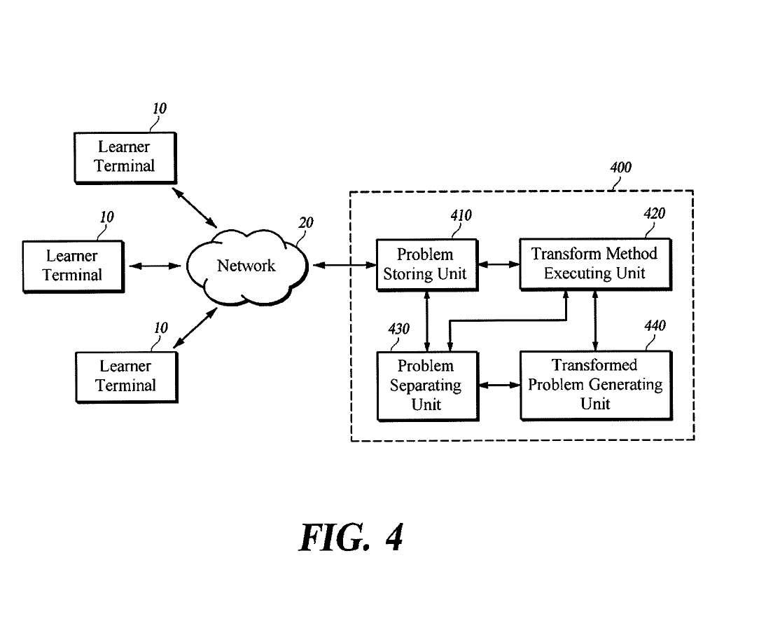

FIG. 4 is a diagram of a cloud computing service providing apparatus 400 according to at least one embodiment of the present disclosure. The cloud computing service providing apparatus 400 may be connected to a learner terminal 10 through a cloud computing environment such as a network 20. The cloud computing service providing apparatus 400 may include a problem storing unit 410, a transform method executing unit 420, a problem separating unit 430 and a transformed problem providing unit 440. The cloud computing service providing apparatus 400 may be implemented through the mathematics education service system of FIG. 1. Other components of the cloud computing service providing apparatus 400, such as the transform method executing unit 420, the problem separating unit 430 and the transformed problem providing unit 440 are implemented by one or more processors and/or application-specific integrated circuits (ASICs).

The problem storing unit 410 may store various types of basic problems to be provided to the learner terminal 10. For example, the problem storing unit 110 may store various types of basic problems of a quadratic equation, a cubic equation, a trigonometric function, a limit, and the like.

The transform method executing unit 420 executes a plurality of problem transform methods, including a problem transform method by number and equation manipulation, a problem transform method by rephrasing, and a problem transform method by proposition manipulation. Herein, the problem transform method by the number and equation manipulation may be classified into a problem transform method by number manipulation and a problem transform method by equation manipulation. Since the respective detailed methods are substantially identical to those described above, a description thereof will be omitted.

The problem separating unit 430 receives the solution and answer of the learner from the learner terminal 10, collects equations used in the relevant mathematical problem in correspondence to the received solution and answer of the learner, separates one or more terms by parsing the collected equations, and separates a constant and a variable from each of the separated terms. At this time, the problem separating unit 430 may divide a mathematical problem into a condition part and a goal part. Examples of condition implication words in the mathematical problem include ‘with respect to’, ‘if’, ‘assuming’, ‘let's set’, and ‘however’. Besides them, there may exist various condition implication words, and these may be collected to set a group of condition implication words before storing. Since a sentence used in a general mathematical problem is standardized, it is not difficult to preset and store a group of condition implication words. The mathematical problem may be divided into a condition part and a goal part, based on the set group of condition implication words.

The transformed problem providing unit 440 generates a new mathematical problem through transform of a basic problem stored in the problem storing unit 410 by applying at least one problem transform method to the equations, which are collected by the problem separating unit 430, and the constant and the variable of each of the separated terms, and then provides the learner terminal 10 with the new mathematical problem. At this time, the transformed problem providing unit 440 may selectively apply the problem transform method according to the solution and answer of the learner, which are received from the learner terminal 10. For example, if it is determined that the learner is weak to the problem type of the transformed problem TP5 of the original problem OP2, a new problem generated by applying the same problem transform method as the transformed problem TP5 may be provided to the learner terminal 10.

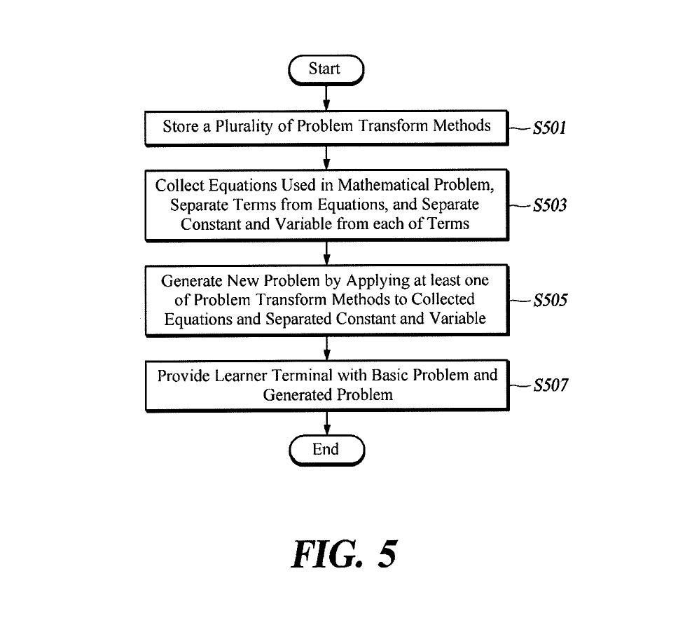

FIG. 5 is a flowchart of a mathematics education service method performed by the mathematics education service system of FIG. 1.

Referring to FIGS. 1 and 5, the problem storing unit 110 may store a plurality of types of mathematical problems (S501). For example, the problem storing unit 110 may store various types of basic problems of a quadratic equation, a cubic equation, a trigonometric function, a limit, and the like.

The transform method executing unit 120 may store a plurality of problem transform methods, including a problem transform method by number and equation manipulation, a problem transform method by rephrasing, and a problem transform method by proposition manipulation, and selectively execute at least one of the problem transform methods.

The problem separating unit 130 collects equations used in mathematical problems, separates one or more terms by parsing the collected equations, and separates a constant and a variable from each of the separated terms (S503). At this time, the problem separating unit 130 may divide the mathematical problem into a condition part and a goal part. Examples of condition implication words in the mathematical problem include ‘with respect to’, ‘if’, ‘assuming ’, ‘let's set’, and ‘however’, and these may be collected to set a group of condition implication words before storing. Since a sentence used in a general mathematical problem is standardized, it is not difficult to preset and store a group of condition implication words. The mathematical problem may be divided into a condition part and a goal part, based on the set group of condition implication words.

The problem generating unit 140 generates a new mathematical problem through transform of a basic problem stored in the problem storing unit 110 by applying at least one problem transform method to the equations, which are collected by the problem separating unit 130, and the constant and the variable of each of the separated terms (S505).

The mathematics education service system 100 provides the learner terminal 10 connected via the network 20 with the basic problem stored in the problem storing unit 110 or the mathematical problem generated by the problem generating unit 140 (S507).

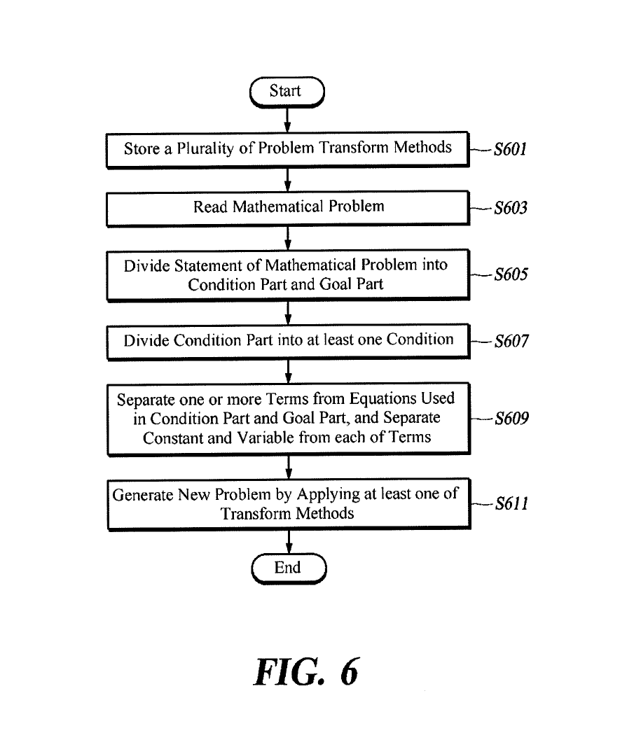

FIG. 6 is a flowchart of a mathematical problem analyzing and generating method performed by the mathematical problem analyzing and generating apparatus of FIG. 2.

Referring to FIGS. 2 and 6, the transform method executing unit 240 may store a plurality of problem transform methods, including a problem transform method by number and equation manipulation, a problem transform method by rephrasing, and a problem transform method by proposition manipulation, and selectively execute at least one of the problem transform methods (S601).

The problem reading unit 210 reads a statement of a mathematical problem (S603). Generally, the statement of the mathematical problem includes a combination of natural language texts and equations. Herein, for convenience, it is assumed that the equation is expressed by a contents based mathematical markup language (MathML). However, the equation may not be expressed by the contents based MathML, and the equation may also be described by a certain different language in which each number of the equation and the meaning of the equation are assigned.

The problem dividing unit 220 divides the statement of the mathematical problem into a condition part and a goal part (S605). As described above, examples of condition implication words in the mathematical problem include ‘with respect to’, ‘if’, ‘assuming’, ‘let's set’, and ‘however’. Besides them, there may exist various condition implication words, and these may be collected to set a group of condition implication words before storing. The mathematical problem may be divided into a condition part and a goal part, based on the set group of condition implication words.

The condition part of the mathematical problem may include a plurality of conditions. In this case, the problem separating unit 230 separates the respective conditions (S607). For example, in the case of the above-described mathematical problem OP1, the condition part includes ‘COND1=equation 2x²+3x+2=0’ and ‘COND2=two roots are α and β’. In order for division into a plurality of conditions, the condition part may be separated by the front and rear of a connective such as ‘and or the like.

The problem separating unit 230 collects equations used in the mathematical problem, separates one or more terms by parsing the collected equations, and separates a constant and a variable from each of the separated terms (S609).

The transform method executing unit 240 executes a plurality of problem transform methods, including a problem transform method by number and equation manipulation, a problem transform method by rephrasing, and a problem transform method by proposition manipulation. The problem generating unit 250 generates a new applied mathematical problem by applying at least one problem transform method to the collected equations and the constant and variable of each of the separated terms (S611).

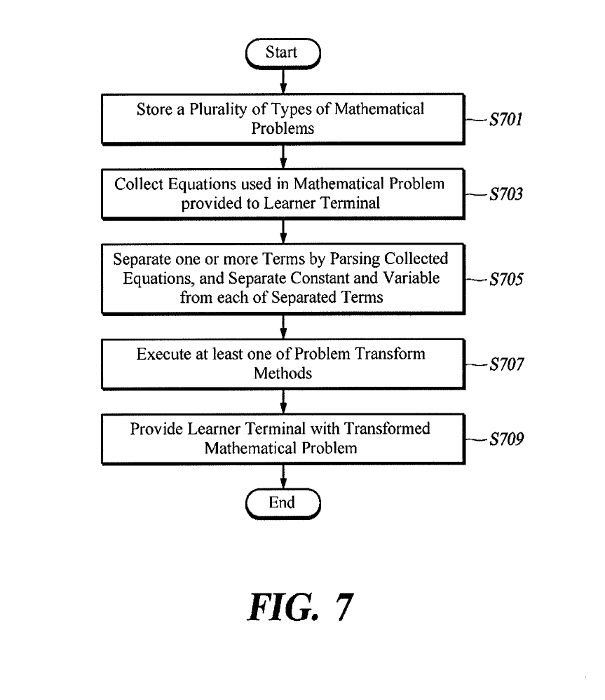

FIG. 7 is a flowchart of a cloud computing service providing method according to at least one embodiment of the present disclosure.

Referring to FIGS. 4 and 7, the problem storing unit 410 may store various types of basic problems to be provided to the learner terminal 10 (S701). For example, the problem storing unit 110 may store various types of basic problems of a quadratic equation, a cubic equation, a trigonometric function, a limit, and the like.

The problem separating unit 430 receives the solution and answer of the learner from the learner terminal 10 in correspondence to the mathematical problem provided by the learner terminal 10, and collects equations used in the corresponding mathematical problem in correspondence to the received solution and answer of the learner (S703). In addition, the problem separating unit 430 separates one or more terms by parsing the collected equations, and separates a constant and a variable from each of the separated terms (S705). At this time, the problem separating unit 430 may divide the mathematical problem into a condition part and a goal part. Examples of condition implication words in the mathematical problem include ‘with respect to’, ‘if’, ‘assuming’, ‘let's set’, and ‘however. Besides them, there may exist various condition implication words, and these may be collected to set a group of condition implication words before storing. Since a sentence used in a general mathematical problem is standardized, it is not difficult to preset and store a group of condition implication words. The mathematical problem may be divided into a condition part and a goal part, based on the set group of condition implication words.

The transform method executing unit 420 executes at least one of a plurality of problem transform methods, including a problem transform method by number and equation manipulation, a problem transform method by rephrasing, and a problem transform method by proposition manipulation (S707). Herein, the problem transform method by the number and equation manipulation may be classified into a problem transform method by number manipulation and a problem transform method by equation manipulation. Since the respective detailed methods are substantially identical to those described above, a description thereof will be omitted.

The transformed problem providing unit 440 provides the learner terminal 10 with a new mathematical problem transformed by applying at least one problem transform method to the equations collected by the problem separating unit 430, and the constant and the variable of each of the separated terms (S709). At this time, the transformed problem providing unit 440 may selectively apply the problem transform method according to the solution and answer of the learner, which are received from the learner terminal 10. For example, if it is determined that the learner is weak to the problem type of the transformed problem TP5 of the original problem OP2, a new problem generated by applying the same problem transform method as the transformed problem TP5 may be provided to the learner terminal 10. According to the present disclosure as described above, transformed mathematical problems can be provided so as to enhance a learner's understanding and enable a learner to be well acquainted with the exact evaluation factors as intended by an examiner. In addition, according to some embodiments of the present disclosure as described above, various problem types can be provided to a learner through a method of transforming a problem by changing numbers in a single problem, manipulating equations, rephrasing a problem statement part, or manipulating a proposition. Therefore, the learner can comprehend the examiner's intention, instead of simple memorization of formulas. As a result, the learner can enhance the practical ability of problem solution.

As described above, the present disclosure is highly useful for application in the fields of a mathematics education service system and method, and a mathematical problem analyzing and generating apparatus and method, because transformed mathematical problems can be provided so as to enhance a learner's understanding and enable a learner to be well acquainted with the exact evaluation factors as intended by an examiner. In addition, various problem types can be provided to learners through a method of transforming a problem by changing numbers in a single problem, manipulating equations, rephrasing a problem statement part, or manipulating a proposition. Therefore, the learners can comprehend the examiner's intention, instead of simple memorization of formulas. As a result, the learners can enhance the practical ability of problem solution. Some embodiments as described above may be implemented in the form of one or more program commands that can be read and executed by a variety of computer systems and be recorded in any non-transitory, computer-readable recording medium. The computer-readable recording medium may include a program command, a data file, a data structure, etc. alone or in combination. The program commands written to the medium are designed or configured especially for the at least one embodiment, or known to those skilled in computer software. Examples of the computer-readable recording medium include magnetic media such as a hard disk, a floppy disk, and a magnetic tape, optical media such as a CD-ROM and a DVD, magneto-optical media such as an optical disk, and a hardware device configured especially to store and execute a program, such as a ROM, a RAM, and a flash memory. Examples of a program command include a premium language code executable by a computer using an interpreter as well as a machine language code made by a compiler. The hardware device may be configured to operate as one or more software modules to implement one or more embodiments of the present disclosure. In some embodiments, one or more of the processes or functionality described herein is/are performed by specifically configured hardware (e.g., by one or more application specific integrated circuits or ASIC(s)). Some embodiments incorporate more than one of the described processes in a single ASIC. In some embodiments, one or more of the processes or functionality described herein is/are performed by at least one processor which is programmed for performing such processes or functionality. Although exemplary embodiments of the present disclosure have been described for illustrative purposes, those skilled in the art will appreciate that various modifications, additions and substitutions are possible, without departing from the various characteristics of the disclosure. That is, it is understood that the present disclosure should not be limited to these embodiments but various changes and modifications can be made by one ordinarily skilled in the art within the subject matter, the spirit and scope of the present disclosure as hereinafter claimed. Specific terms used in this disclosure and drawings are used for illustrative purposes and not to be considered as limitations of the present disclosure. Exemplary embodiments of the present disclosure have been described for the sake of brevity and clarity. Accordingly, one of ordinary skill would understand the scope of the claimed invention is not limited by the explicitly described above embodiments but by the claims and equivalents thereof.

1. A mathematics education service system for providing a mathematics education service to a learner terminal, the mathematics education service system comprising:
a problem storing unit configured to store at least one mathematical problem;
a transform method executing unit configured to execute a plurality of problem transform methods;
a problem separating unit configured to collect equations used in the mathematical problem, separate one or more terms from the collected equations by parsing the collected equations, and separate a constant and a variable from each of the separated one or more terms; and
a problem generating unit configured to generate another applied problem of the mathematical problem by applying at least one of the problem transform methods (i) to the collected equations, and (ii) to the constant and the variable of each of the separated one or more terms,
wherein the system is configured to provide the mathematical problem and the generated another problem to the learner terminal.

2. The mathematics education service system of claim 1, wherein the plurality of problem transform methods include at least one of
a first problem transform method by a number and equation manipulation,
a second problem transform method by a rephrasing, and
a third problem transform method by a proposition manipulation.

3. The mathematics education service system of claim 2, wherein the first problem transform method is classified into at least one of
a problem transform method by number manipulation, and
a problem transform method by equation manipulation.

4. The mathematics education service system of claim 2, wherein the second problem transform method is classified into at least one of
a problem transform method using dependency of conditions,
a problem transform method by inverse of proposition, and
a problem transform method by addition or deletion of conditions.

5. The mathematics education service system of claim 2, wherein the third problem transform method comprises rephrasing a statement part of the mathematical problem.

6. An apparatus for analyzing and generating mathematical problems, comprising:
a problem separating unit configured to collect equations used in a mathematical problem, separate one or more terms from the collected equations by parsing the collected equations, and separate a constant and a variable from each of the separated one or more terms;
a transform method executing unit configured to execute a plurality of problem transform methods; and
a problem generating unit configured to generate another applied problem of the mathematical problem by applying at least one of the problem transform methods (1) to the collected mathematical problems, and (2) to the constant and the variable of each of the separated one or more terms.

7. The apparatus of claim 6, further comprising:
a problem reading unit configured to read the mathematical problem; and
a problem dividing unit configured to divide a statement part of the mathematical problem into a condition part and a goal part.

8. The apparatus of claim 7, wherein the problem dividing unit is configured to preset and store a group of condition implication words, and divide the condition part and the goal part, based on the preset condition implication words.

9. The apparatus of claim 6, wherein the plurality of problem transform methods executed by the transform method executing unit include at least one of
a first problem transform method by a number and equation manipulation,
a second problem transform method by a rephrasing, and
a third problem transform method by a proposition manipulation.

10. The apparatus of claim 9, wherein the transform method executing unit is configured to execute the first problem transform method by the number and equation manipulation by changing coefficients of each of the separated one or more terms.

11. The apparatus of claim 9, wherein the transform method executing unit is configured to execute the first problem transform method by the number and equation manipulation with another equation generated (i) through deleting at least one term from each of the separated one or more terms, adding another term to each of the separated one or more terms, or (ii) through an arithmetic operation of each of the separated one or more terms.

12. The apparatus of claim 9, wherein the transform method executing unit is configured to execute the second problem transform method by the rephrasing by using at least one of
a method of changing order of arrangement of terms in the collected equations,
a method of factorizing or expanding the collected equations,
a method of expressing the collected equations with words,
a method of abbreviating a target object expressed with words into an equation, and
a method of substituting the equations with graphs or pictures.

13. The apparatus of claim 9, wherein the transform method executing unit is configured to execute the third problem transform method by the proposition manipulation by using at least one of
a method of using dependency of conditions of the mathematical problem,
a method of exchanging roles of the condition part and the goal part in the mathematical problem, and
a method of adding or deleting other conditions to or from the condition part of the mathematical problem.

14. A method for analyzing and generating mathematical problems performed by an apparatus for analyzing and generating mathematical problems, the method comprising:
reading a mathematical problem;
dividing a statement part of the mathematical problem into a condition part and a goal part;
collecting equations used in the mathematical problem, separating one or more terms from the collected equations by parsing the collected equations, and separating a constant and a variable from each of the separated one or more terms; and
generating another applied problem of the mathematical problem by applying at least one of problem transform methods (a) to the collected equations, and (b) to the constant and the variable of each of the separated terms.

15. The method of claim 14, wherein the plurality of problem transform methods include at least one of
a first problem transform method by a number and equation manipulation,
a second problem transform method by a rephrasing, and
a third problem transform method by a proposition manipulation.

16. The method of claim 14, wherein the dividing comprises
presetting and storing a group of condition implication words, and
dividing the condition part and the goal part based on the preset condition implication words.

17. The method of claim 15, further comprising:
executing the first problem transform method by the number and equation manipulation by changing coefficients of each of the separated one or more terms.

18. The method of claim 15, further comprising:
executing the first problem transform method by the number and equation manipulation with another equation generated (i) through deleting at least one term from each of the separated one or more terms, adding another term to each of the separated one or more terms, or (ii) through an arithmetic operation of each of the separated one or more terms.

19. The method of claim 15, further comprising:
executing the second problem transform method by the rephrasing by using at least one of
a method of changing order of arrangement of terms in the collected equations,
a method of factorizing or expanding the collected equations,
a method of expressing the collected equations with words,
a method of abbreviating a target object expressed with words into an equation, and
a method of substituting the equations with graphs or pictures.

20. The method of claim 15, further comprising:
executing the third problem transform method by the proposition manipulation by using at least one of
a method of using dependency of conditions of the mathematical problem,
a method of exchanging roles of the condition part and the goal part in the mathematical problem, and
a method of adding or deleting other conditions to or from the condition part of the mathematical problem.
